(19) United States
(12) Patent Application Publication
(10) Pub. No.: US 2006/0042874 A1
(43) Pub. Date: Mar. 2, 2006

(54) Acoustical and firewall barrier assembly

(76) Inventors: Matthew Foster, Lake Bluff, IL (US); Frank Schwab, Arlington Heights, IL (US)

Correspondence Address: EVEREST INTELLECTUAL PROPERTY LAW GROUP, P. O. BOX 708, NORTHBROOK, IL, 60065, US

(21) Appl. No.: 10/925,705

(22) Filed: Aug. 24, 2004

(51) Int. Cl. E04B 9/00; E04B 1/94; E04B 1/82; E04B 2/02; B64F 1/26; G10K 11/00; E04H 17/00; E04B 1/00

(52) U.S. Cl. 181/285; 181/290; 181/210

(57) ABSTRACT

The present invention provides an acoustical firewall attenuating assembly. The assembly includes a first frame assembly having a first plate, a second plate and a first plurality of elongate members spaced from one another and extending between the first plate and the second plate. A structure is spaced from the first frame assembly and has an outer surface. A cement wall is positioned between the first frame and the structure and is attached to at least the first frame assembly by a first vibration dampener.

### CROSS-REFERENCE TO RELATED APPLICATION

Not Applicable.

### FEDERALLY SPONSORED RESEARCH OR DEVELOPMENT

Not Applicable.

### BACKGROUND OF THE INVENTION

1. Technical Field

The present invention pertains to acoustical and firewall barrier assemblies particularly suitable for frame construction.

2. Background

Stud wall construction of walls and other structures is in widespread use in the United States. Typically, stud wall construction has wood or metal studs. Wood framing includes, for example, a series of 2 by 4 wood studs, generally 1½ by 3½ inches in cross-sectional size. The studs extend vertically between, and are secured to, a lower stud plate on the floor and double upper stud plates at the ceiling. In metal stud construction, the studs are made of sheet metal having a generally C-shaped cross-section.

In conventional stud wall construction the walls are finished by securing to the studs gypsum board, plywood, plaster or the like (called “wall board” for convenience); and sometimes insulation of various types is installed between the studs and the wall boards. Such stud wall construction provides little barrier to fire or sound transfer.

### SUMMARY OF THE INVENTION

The present invention provides an acoustical firewall attenuating assembly. The assembly includes a first frame assembly having a first plate, a second plate and a first plurality of elongate members spaced from one another and extending between the first plate and the second plate. A structure is spaced from the first frame assembly and has an outer surface. A cement wall is positioned between the first frame and the structure and is attached to at least the first frame assembly by a first vibration dampener.

The present invention further provides a method for fabricating an acoustical firewall assembly. The steps include: (1) providing a cement element, (2) inserting the cement element between a first frame structure and a second structure, and (3) attaching the cement element to the first frame structure with a vibration dampener.

The present invention also provides an anchor for attaching a cement wall to a structure.

These and other aspects and attributes of the present invention will be discussed with reference to the following drawings and accompanying specification.

### BRIEF DESCRIPTION OF THE DRAWINGS

FIG. 1 is a perspective view partially broken away of an acoustical firewall barrier assembly.

FIG. 2 is a top view of a portion of an acoustical firewall barrier assembly.

FIG. 3 is an end view of an anchor and vibration dampener.

FIG. 4 is another end view of an anchor and vibration dampener.

FIG. 5 is a top view of a portion of an acoustical firewall barrier assembly.

### DETAILED DESCRIPTION OF THE INVENTION

The present invention is susceptible to embodiments in many different forms. Preferred embodiments of the invention are disclosed with the understanding that the present disclosure is to be considered as exemplifications of the principles of the invention and are not intended to limit the broad aspects of the invention to the embodiments illustrated.

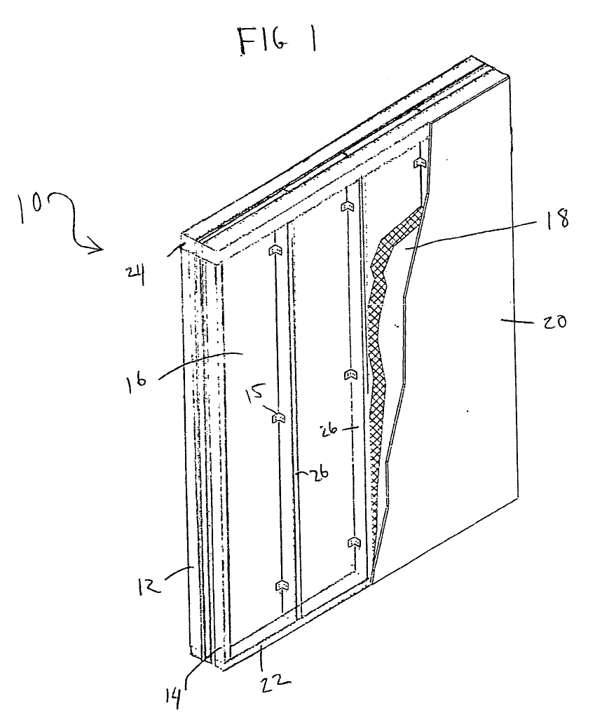

FIG. 1 shows an acoustical firewall barrier assembly 10 having a first structure 12 spaced from a second structure 14, a cement wall 16 positioned between the first and second structures 12 and 14 and spaced a distance from both, a plurality of vertically spaced vibration dampeners 15 connecting the cement wall 16 to the first structure, optional insulating material 18 and optional wall board material 20.

The first and/or the second structure can be a planar structure such as a wall or floor or the like. It is contemplated these structures could be made from wood, concrete, metal, fabric, plastic, paperboard or the like. It is also contemplated the first structure can be a frame structure and the second structure can be a planar structure. In a preferred form of the invention, the first structure and the second structure are of a conventional stud wall frame construction including a base stud plate 22, and an upper stud plate 24. The base stud plate 22 is typically secured to a floor and the top stud plate is secured to a ceiling. The upper stud plate 24 can include two stud plates stacked on top of one another, although only a single top stud plate is shown. A plurality of studs 26 extend vertically between, and are secured at their ends to, the floor stud plate 22 and the ceiling stud plate 24.

FIG. 1 shows the floor stud plate, the ceiling stud plate, and the vertically extending studs are made of wood; these members usually are 1½ by 3½ inches in cross-sectional size in the U.S. The studs 26 are spaced 16 inches on center according to standard U.S. practice. Such stud wall frame is of conventional type and the construction thereof will be apparent to those in the art from the description herein. It is contemplated replacing the components of the wooden stud frame with components made from metal, plastic, or a composite material.

The cement wall 16 is fabricated from structural elements of a cement-like, concrete-like, limestone-like material or other similar material. The elements can be in the form of blocks or boards or the like. In one preferred form of the invention the cement wall 16 is fabricated from autoclave aerated concrete (AAC). AAC is lightweight compared to normal concrete. For example, typical AAC weighs one-fourth to one-fifth the weight of normal concrete, which weighs in the range 130 to 145 lbs/ft. AAC has extreme thermal properties. It displays no spalling of material when exposed to temperatures at or approaching 2000 degrees Fahrenheit. AAC is an inorganic material resistant to weather decay and pest attack. AAC also provides significant acoustical barrier properties.

AAC is typically formed as a blend of sand or fly ash, lime, Portland cement, water, and an expansion agent of aluminum powder or paste. The mixture is usually cast into large molds and allowed to expand to a volume greater than the original semi-fluid mass. The expanded mass is sliced to desired dimensions and shapes into the structural elements mentioned above. The processed elements are then placed into large pressurized chambers called autoclaves to complete the curing or hardening of the finished product. The structural elements are typically cured for 8-12 hours at 12-13 atmospheric pressures at 360-385 degrees Fahrenheit.

Aerated concrete is also produced in structural elements such as panels and blocks like autoclaved aerated concrete. However, aerated concrete product is allowed to air cure in normal single atmospheric pressures and ambient temperatures. The process for achieving maximum strength takes longer. Typical curing time for aerated concrete is 7-28 days versus 20-24 hours for autoclaved aerated concrete.

The concrete wall board panels and blocks are available in numerous shapes and sizes. The wall board panels are typically elongate having a length dimension substantially greater than the width dimension. Panel sizes include lengths of from 4 to 20 feet, widths of two to 8 feet and thicknesses of from 1 to 8 inches. The advantage of such elongate wall boards is that they may be easily formed into a wall when compared to building walls by stacking cement blocks. The concrete wall board should be spaced from the first frame and the second frame by a distance 29 (FIGS. 2 and 5) to assist in isolating the cement board from the frames for the purposes of isolating vibrations in one structure from the other.

The distance 29 between the wall 16 and the first structure and the distance between the wall 16 and the second structure can be of substantially the same dimension to form a symmetrical structure, or, in a more preferred form of the invention, the distances will be different to define an asymmetrical structure. The difference in the distances will typically be 3 inches or less and more preferably will be 1½ inches or less.

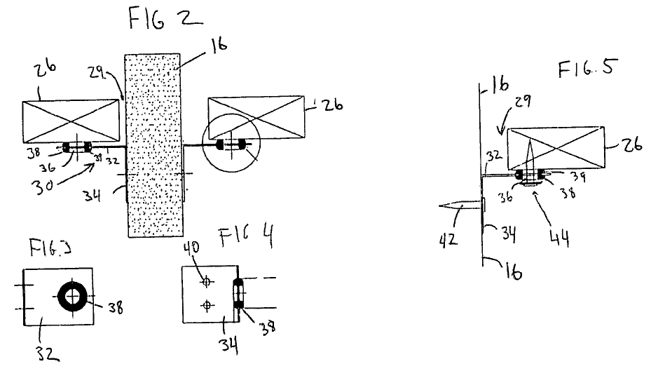

The vibration dampeners 15 are shown to be positioned, one each, on a generally L-shaped anchor 30 or bracket. The anchor 30 has a first face 32 and a second face 34 extending in directions transverse to one another, and, in a preferred form of the invention, the first face 30 extends in a direction substantially perpendicular to the second face 32. FIG. 3 shows a portion of the first face 32 is removed to define a through-hole 36. The hole 36 is generally centrally disposed on the first face 30. A grommet 38 is inserted into the through-hole 36 and has a portion or portions 39 extending away from the first face 32. The grommet 38 is effective to dampen vibrations in the first structure 12 so they are not transmitted through the wall assembly 10 or they are substantially diminished.

FIGS. 4 and 5 show that the second face 34 also has one or more holes 40 to accommodate a fastener 42 such as nails or screws for attaching the second face 34 to the cement board 16. Similarly, a fastener and washer combination 44 is used to attach the first face 32 to a stud 26.

The anchor 30 can be made from any suitable material including metal, polymer, wood or a composite material. In a preferred form of the invention, the anchor will be fabricated from a material that fails at temperatures of approximately 800° F.-1600° F. and more preferably in excess of 1000° F. What is meant by the term “fail” is the anchor melts or degrades to the point where it can no longer effectively serve as an anchor. Suitable metals include aluminum, aluminum alloys, and those metals having a melting point temperature within the limits set forth above. Suitable polymers include those high temperature resistant polymers and can be a thermoplastic-type polymer or thermosetting-type polymer. Suitable polymers include, but are not limited to, polyimides, poly(ethersulfones), poly(phenylene sulfides), poly(phenylene oxide), polyketones, engineering thermoplastics or other temperature resistant polymers.

The vibration dampener can be made from polymers, natural rubber, and synthetic rubbers. The vibration dampener can take on many forms including objects or assemblies having a body capable of dampening a vibration. The object can dampen the vibration by virtue of a material property of elasticity. The object can also have a spring or like device for dampening vibrations. In one preferred form of the invention, the vibration dampener is a grommet made from neoprene. The vibration dampening material could also be applied to a portion of the first face 32 or to both the first face 32 and the second face 34 by other techniques such as applying the vibration dampening material to a portion of the faces or over essentially the entire surface of the first face or the second face or on both the first face and the second face 32, 34 to define a layer of dampening material extending away from the faces. The vibration dampener can take on other forms than a grommet and do not necessarily have to be associated with an anchor or bracket.

Suitable polymers to provide vibration dampening have elastomeric properties and can be a polyolefin, EVA, styrene and hydrocarbon copolymers, styrene and hydrocarbon block copolymers, polyamides, polyesters, polyethers and the like.

The optional insulating material can be provided to enhance the thermal and acoustical insulation properties and can be fiberglass, foamed polystyrene, HDPE type insulation or other type of insulation that is commonly available.

The wall board 20 material can be planar material to attach an outer surface of the first structure or the second structure or both. The wall board material can be sheet rock, drywall, plaster, particle board, plywood, tile, cardboard, plastic sheeting or the like.

The acoustical wall barrier assembly 10 should have high acoustical barrier characteristics. In a preferred form of the invention, the assembly 10 will have a sound transfer coefficient (STC) of about 50 or higher and more preferably will be from about 50 to about 65. It is also desirable for the acoustical barrier to enhance the fire rating for the wall barrier assembly 10. In a preferred form of the invention, the fire rating will be 2 hours or greater and preferably from 2 to 4 hours.

The acoustical wall barrier assembly 10 can be easily assembled or retrofitted to existing structures. The method includes the steps of: inserting the cement wall 16 between the first structure and the second structure; and attaching the cement wall 16 to the first structure with one or more vibration dampeners.

The step of inserting the cement wall, in a preferred form, includes the step of building a wall from cement blocks or cement boards as described herein. In a most preferred form of the invention the step of inserting a cement wall includes the step of inserting a cement board between the first frame structure and the second structure by sliding a cement board between the first and second structures and then attaching the cement board to an outer portion of one or more studs using a plurality of sound dampeners spaced along the length of the stud or studs. Cement boards made from AAC are typically light enough for one or more persons to accomplish this step by hand. It is also possible to utilize a crane to assist in guiding a cement board between the first and second structures.

FIG. 1 shows three vertically extending cement boards that extend the full length of the studs and extends from the bottom plate to the top plate. It is contemplated the cement board can extend only a portion of the length of a stud provided that the overall sound dampening is not significantly impacted. In a preferred form of the invention a thin bed of mortar is applied to a seam formed between two abutting lateral edges of two adjacent cement boards.

Additional steps of inserting the optional insulation and applying wall board to an outer surface of the first frame and the second frame (if necessary) completes the acoustical firewall barrier structure.

In the event of a fully engaged fire, the anchors are designed to fail so that the wall board can fall away from the cement board and not pull the cement board with it. This helps maintain the acoustical firewall barrier 10 substantially intact for 2 to 4 hours in a fire.

While specific embodiments have been illustrated and described, numerous modifications come to mind without departing from the spirit of the invention and the scope of protection is only limited by the scope of the accompanying claims.

What is claimed is:

1. An acoustical attenuating assembly comprising:
an elongate member having a first and second end;
a cement wall spaced from the elongate member;
an anchor attaching the cement wall to the elongate member; and
a vibration dampener on the anchor and contacting the elongate member.

2. The assembly of claim 1, wherein the cement wall is fabricated from a cement board or a cement block.

3. The assembly of claim 1 wherein the cement wall is fabricated from an elongated cement board.

4. The assembly of claim 2, wherein the anchor has a first surface for connecting to the member and a second face for connecting to the cement wall.

5. The assembly of claim 4, wherein the first face is transverse to the second face.

6. The assembly of claim 5, wherein the first face is substantially perpendicular to the second face.

7. The assembly of claim 1, wherein the dampener is fabricated from a material selected from the group consisting of polymers, natural rubber, and synthetic rubbers.

8. The assembly of claim 7, wherein the sound dampener is attached to the first or second face of the anchor and extends away a distance therefrom.

9. The assembly of claim 8, wherein the first face has a portion removed to define a hole therethrough and the dampener is positioned within the hole.

10. The assembly of claim 9, wherein the dampener is a grommet inserted through the hole.

11. The assembly of claim 1, wherein the elongate member is a stud extending between a first surface and a second surface.

12. The assembly of claim 11, further comprising a second elongate member spaced from the first elongate member, the second elongate member being attached to the cement board and together with the first elongate member, the cement board, and the first surface and the second surface defines an enclosed space.

13. The assembly of claim 1, wherein the cement wall is fabricated from autoclave aerated concrete.

14. An acoustical attenuating firewall assembly comprising:
a first frame assembly having a first plate, a second plate and a first plurality of elongate members spaced from one another and extending between the first plate and the second plate; and
a cement wall spaced from the first frame and attached to at least a portion of the first frame with a vibration dampener.

15. The assembly of claim 14, wherein the assembly has a sound transfer coefficient of greater than 50.

16. The assembly of claim 14, wherein the assembly has a sound transfer coefficient of from about 50 to about 65.

17. The assembly of claim 14, wherein the vibration dampener is fabricated from a material selected from the group consisting of polymers, natural rubbers, and synthetic rubbers.

18. The assembly of claim 17, wherein the vibration dampener is positioned on an anchor.

19. The assembly of claim 18, wherein the anchor has a first face for connecting to the first frame and a second face for connecting to the wall.

20. The assembly of claim 19, wherein the first face is transverse to the second face.

21. The assembly of claim 20, wherein the first face is substantially perpendicular to the second face.

22. The assembly of claim 18, wherein the anchor is substantially L shaped.

23. The assembly of claim 18, wherein the vibration dampener is attached to the anchor and extends away a distance therefrom.

24. The assembly of claim 23, wherein the vibration dampener is attached to the first face of the anchor.

25. The assembly of claim 24, wherein the vibration dampener is essentially centrally disposed on the first face.

26. The assembly of claim 25, wherein the first face has a portion removed to define a hole therethrough and the vibration dampener is positioned within the hole.

27. The assembly of claim 26, wherein the dampener is a grommet inserted through the hole.

28. The assembly of claim 18, wherein the anchor is fabricated from aluminum.

29. The assembly of claim 14, wherein the cement wall is fabricated from autoclave aerated concrete.

30. An acoustical firewall attenuating assembly comprising:
a first frame assembly having a first plate, a second plate and a first plurality of elongate members spaced from one another and extending between the first plate and the second plate;
a structure spaced from the first frame assembly and having an outer surface; and
a cement wall positioned between the first frame and the structure and being attached to at least the first frame assembly by a first vibration dampener.

31. The assembly of claim 30, wherein the structure comprises a second frame assembly having a third plate, a fourth plate and a second plurality of elongate members spaced from one another and extending between the third plate and the fourth plate.

32. The assembly of claim 31, wherein the cement wall is attached to the second frame with a second vibration dampener.

33. The assembly of claim 30, wherein the vibration dampener is fabricated from a material selected from the group consisting of polymers, natural rubbers, and synthetic rubbers.

34. The assembly of claim 33 wherein the vibration dampener is positioned on an anchor.

35. The assembly of claim 34, wherein the anchor has a first face for connecting to the first frame and a second face for connecting to the wall.

36. The assembly of claim 35, wherein the anchor is substantially L shaped.

37. The assembly of claim 36, wherein the vibration dampener is attached to the anchor and extends away a distance therefrom.

38. The assembly of claim 30, wherein the elongate members are studs.

39. The assembly of claim 38, wherein the studs are fabricated from a material selected from the group consisting of wood, metal, polymer, and composite material.

40. The assembly of claim 34, wherein the anchor fails at a temperature in excess of 1000° F.

41. The assembly of claim 40, wherein the anchor is fabricated from aluminum.

42. The assembly of claim 30, wherein the assembly has a sound transfer coefficient of greater than 50.

43. The assembly of claim 30, wherein the assembly has a sound transfer coefficient of from about 50 to about 65.

44. The assembly of claim 30, wherein the cement wall is fabricated from autoclave aerated concrete.

45. The assembly of claim 30 wherein the first frame assembly is spaced from the cement wall by a first distance and the structure is spaced from the cement wall by a second distance wherein the first distance is different from the second distance.

46. The assembly of claim 30 wherein the first frame assembly is spaced from the cement wall by a first distance and the structure is spaced from the cement wall by a second distance wherein the first distance is essentially equal to the second distance.

47. A method for fabricating an acoustical firewall assembly comprising:
providing a cement element;
inserting the cement element between a first frame structure and a second structure; and
attaching the cement element to the first frame structure with a vibration dampener.

48. The method of claim 47, wherein the structure comprises a second frame having a third plate, a fourth plate and a second plurality of elongate members spaced from one another and extending between the third plate and the fourth plate.

49. The method of claim 48, wherein the cement element is a cement board or a cement block.

50. The method of claim 47, wherein the vibration dampener is fabricated from a material selected from the group consisting of polymers, natural rubbers, and synthetic rubbers.

51. The method of claim 50, wherein the vibration dampener is positioned on an anchor.

52. The method of claim 51, wherein the anchor is substantially L shaped.

53. The method of claim 52, wherein the vibration dampener is attached to the anchor and extends away a distance therefrom.

54. The method of claim 53, wherein the dampener is a grommet attached to the anchor.

55. The method of claim 54, wherein the anchor is fabricated from aluminum.

56. The method of claim 47, wherein the assembly has a sound transfer coefficient of greater than 50.

57. The method of claim 47, wherein the assembly has a sound transfer coefficient of from about 50 to about 65.

58. The method of claim 47, wherein the step of attaching the board to the first frame structure with a vibration dampener comprises providing a plurality of vibration dampeners and attaching the dampeners along the board and the frame at spaced locations.

59. An anchor for attaching a structure to a cement wall comprising:
a body having a first face and a second face, the first face being transverse to the second face, the body fabricated from a material that fails at a temperature in excess of 1000° F.; and
an elastomeric vibration dampener attached to the first face of the body and extending a distance away therefrom.

60. The anchor of claim 59, wherein the body is substantially L-shaped.

61. The anchor of claim 60, wherein the first face has a through hole and the dampener is positioned therein.

62. The anchor of claim 61, wherein the dampener is made from polymers, natural rubber, and synthetic rubbers.

63. The anchor of claim 62, wherein the dampener is fabricated from neoprene.

64. The anchor of claim 62, wherein the body is fabricated from metal, polymer, wood or a composite material.

65. The anchor of claim 64, wherein the metal is selected from the group consisting of aluminum, and aluminum alloys.
